(19) United States
(12) Patent Application Publication
(10) Pub. No.: US 2024/0009731 A1
(43) Pub. Date: Jan. 11, 2024

(54) NANO SILVER PASTE AND PREPARATION METHOD THEREOF

(71) Applicant: SOLDERWELL MICROELECTRONIC PACKAGING MATERIALS CO., LTD, Guangzhou (CN)

(72) Inventors: Hangwei CAI, Guangzhou (CN); Kun DU, Guangzhou (CN); Simei XU, Guangzhou (CN)

(73) Assignee: SOLDERWELL MICROELECTRONIC PACKAGING MATERIALS CO., LTD, Guangzhou (CN)

(21) Appl. No.: 18/468,587

(22) Filed: Sep. 15, 2023

Related U.S. Application Data
(63) Continuation of application No. PCT/CN2022/073665, filed on Jan. 25, 2022.

(30) Foreign Application Priority Data
Apr. 25, 2021 (CN) 202110447478.9

(51) Int. Cl. B22F 1/0545

(52) U.S. Cl. CPC B22F 1/0545; B22F 2301/255; B22F 2304/058; B22F 2304/056; B22F 2304/054; B22F 2301/30; B22F 2304/10

(57) ABSTRACT

Disclosed are a nano silver paste and a preparation method thereof. The nano silver paste of the present application includes nano silver powder, micron-tin based solder particles, a reducing agent, a dispersing agent, and a diluent. The nano silver paste of the present application is obtained by uniformly mixing the nano silver powder, the micron-tin based solder particles, the reducing agent, the dispersing agent, and the diluent. According to the nano silver paste of the present application, the problems of nano silver paste in the prior art of low stacking density during non-pressure sintering, high porosity, severe volume contraction, susceptibility to cracking, and low interface soldering rate are solved, thereby improving the mechanical properties and reliability of sintering positions.

### CROSS-REFERENCE TO RELATED APPLICATIONS

This application is a continuation of International Application No. PCT/CN2022/073665, filed on Jan. 25, 2022, which claims priority to Chinese Patent Application No. 202110447478.9, filed on Apr. 25, 2021. All of the aforementioned applications are incorporated herein by reference in their entireties.

### TECHNICAL FIELD

The present application relates to the technical field of electronic component packaging, and in particular, to nano silver paste and a preparation method thereof.

### BACKGROUND

As electronic components become increasingly accurate, miniaturized and integrated, inevitably leading to higher packaging density and power density, there are higher and higher requirements on heat dissipation and reliability of packaging. New generation power semiconductors represented by silicon carbide and gallium nitride have the characteristics of wide band gaps, high breakdown voltages, strong thermal stability, and stable switching properties, and are widely applied to the fields such as rail transportation, aerospace, new energy vehicles, and deep sea/deep well exploration.

During service, an interconnect material for a power device is subjected to severe tests of mechanical vibration, thermal stress, high-density currents and power cycling, and traditional tin-based solders no longer meet increasingly demanding reliability requirements, such that there is an urgent need to develop new high temperature resistant interconnect materials and corresponding interconnect processes.

As nano metal particles have the characteristics of high surface energy and low melting points, the use of the nano metal particles to package components has been proposed at home and abroad in recent years. Due to good electrical and thermal conductivity, low-temperature sintering, high reliability, and high-temperature service performance, nano silver paste has become the most promising low-temperature interconnect material. However, since the original stacking density of the nano silver paste is relatively low, the structure of a interconnect device in particular makes it impossible to apply pressure during sintering, or when non-pressure sintering is needed to prevent the pressure from damaging the interconnect device, a large number of uncontrollable pore structures are generated. The compactness of a sintered layer is low, and volume contraction is obvious, such that the sintered layer is prone to cracking, resulting in reduction of an interface soldering rate, reduction of mechanical strength, and great reduction of electrical and thermal conductivity compared with silver blocks. In addition, sintering silver paste generates a large thermal expansion coefficient, such that large thermo-mechanical stress is also generated during service, causing failure of a interconnect position.

### SUMMARY

The present application is mainly intended to provide nano silver paste to overcome disadvantages and shortcomings in the prior art, so as to solve the problems of existing nano silver paste of low stacking density of a sintered layer during non-pressure sintering, severe volume contraction, susceptibility to cracking, and low interface soldering rate, thereby improving the mechanical properties and reliability of interconnect positions.

The present application is further intended to provide a method for preparing nano silver paste.

A first objective of the present application is implemented through the following technical solutions. Nano silver paste includes nano silver powder, micron-tin based solder particles, a reducing agent, a dispersing agent, and a diluent.

A material of the micron-tin based solder particles is a tin-base alloy of which melting point is within a range of 120-250° C., and preferably, is at least one of a SnBi series alloy, a SnBiAg series alloy, a SnAg series alloy, a SnCu series alloy, a SnAgCu series alloy, a SnSb series alloy, a SnSbCu series alloy, a SnSbAg series alloy, a SnAgCuBi series alloy, or a SnAgCuSb series alloy.

An average particle size of the nano silver powder is 5-3000 nm.

Preferably, the average particle size of the nano silver powder is 10-1500 nm.

The nano silver powder is the nano silver powder with one average particle size or a mixture of the nano silver powder with more than two different average particle sizes.

An average particle size of the micron-tin based solder particles is 0.1-100 μm.

Preferably, the average particle size of the micron-tin based solder particles is 0.5-50 μm.

A mass ratio of the nano silver powder to the micron-tin based solder particles is 20-500:1.

Preferably, the mass ratio of the nano silver powder to the micron-tin based solder particles is 30-200:1.

The diluent is at least one of alcohol, hydrocarbon, ketone, or ester.

A mass percent of the diluent in a system is 2%-8%.

The dispersing agent is at least one of polymerized hydrocarbon amide, polymerized hydrocarbon acid salt, or alkyl acid salt.

A mass percent of the dispersing agent in the system is 0.1%-3%.

The reducing agent is at least one of organic acids.

A mass percent of the reducing agent in the system is 0.1%-1.5%.

A method for preparing the nano silver paste includes: uniformly mixing nano silver powder, micron-tin based solder particles, a reducing agent, a dispersing agent, and a diluent, so as to obtain the nano silver paste.

The nano silver powder is obtained by a method of chemically reducing a silver salt solution, and drying a silver deposition layer in a negative pressure environment under 100 Pa.

The micron-tin based solder particles are obtained by grinding tin-based solder through a vacuum grinding machine.

Uniform mixing preferably uses a manner of mechanical stirring or magnetic stirring.

For the low-melting-point micron-tin based solder particles in the nano silver paste, if the amount added is too small, the micron-tin based solder particles are insufficient to fill the void gaps between the silver nanoparticles that are not completely melted; and if the amount added is too much, there are too many low-melting-point phases in a sintered layer, resulting in reduction of the reliability of the sintered layer. Controlling the amount of the low-melting-point micron-tin based solder particles in the nano silver paste is one of the keys to the present application.

If the particle size of the low-melting-point micron-tin based solder particles is too small, on the one hand, if the particle size is smaller, a specific surface area is larger, and the particles are easier to oxidize, and on the other hand, if the particle size is small, the cost of particle manufacturing is high. However, if the particle size is too large, the probability of contact with the nano silver powder in the nano silver paste is reduced, not facilitating the well mixing of the micron-tin based solder particles in the nano silver paste.

The alcohol, the hydrocarbon, the ketone, and the ester are used as the diluent; and when the mass percent of the diluent in an entire nano silver paste system is 2%-8%, the diluent, the micron-tin based solder particles, and the nano silver powder can be uniformly mixed and a paste-like slurry product with moderate viscosity is generated. When the addition of the diluent is too little, the viscosity is relatively large, such that the paste-like slurry product cannot be formed. On the one hand, it is not conducive to uniformly mixing the diluent, the micron-tin based solder particles, and the nano silver powder, and on the other hand, it is not conducive to placing the product on a sintered face. However, when the addition of the diluent is too much, on the one hand, if the viscosity is too small, collapsing easily occurs when the product is placed on the sintered face, such that it is not conducive to a interconnect operation; and on the other hand, if the diluent is too much, during sintering and heating up, the volatilization of the diluent produces excessive gases, which adhere to the walls and pipes of a sintering furnace and make it difficult to clean, or create a large number of voids in the sintered layer.

The polymerized hydrocarbon amide, the polymerized hydrocarbon acid salt, and the alkyl acid salt are used as the dispersing agent; and when the mass percent of the dispersing agent in the entire nano silver paste system is 0.1%-3%, the micron-tin based solder particles and the nano silver powder can be uniformly dispersed. When the addition of the dispersing agent is too little, it is not conducive to uniform dispersion of the micron-tin based solder particles and the nano silver powder, resulting in aggregation. However, when the addition of the dispersing agent is too much, on the one hand, if the viscosity is too small, collapsing easily occurs when the product is placed on the sintered face, such that it is not conducive to the interconnect operation; and on the other hand, if the dispersing agent is too much, during sintering and heating up, the volatilization of the dispersing agent produces excessive gases, which adhere to the walls and pipes of the sintering furnace and make it difficult to clean, or create a large number of voids in the sintered layer.

The organic acids are used as the reducing agent; and when the mass percent of the reducing agent in the entire nano silver paste system is 0.1%-1.5%, oxides on surfaces of the micron-tin based solder particles and the nano silver powder can be effectively removed during sintering. When the addition of the reducing agent is too little, the reducing agent, the micron-tin based solder particles, and the nano silver powder are difficult to uniform mix, such that it is difficult to ensure that the micron-tin based solder particles and the nano silver powder can be in full and effective contact with the reducing agent, and it is difficult to ensure that oxide layers on the surfaces of the micron-tin based solder particles and the nano silver powder are fully and effectively removed. However, when the addition of the reducing agent is too much, on the one hand, if the viscosity is too small, collapsing easily occurs when the product is placed on the sintered face, such that it is not conducive to the interconnect operation; and on the other hand, if the reducing agent is too much, during sintering and heating up, the volatilization of the reducing agent produces excessive acid gases, which adhere to and corrode the walls and pipes of the sintering furnace, or create a large number of voids in the sintered layer.

Compared with the prior art, the present application has the following beneficial effects.

Firstly, the low-melting-point micron-tin based solder particles are uniformly mixed in the nano silver paste in the present application, and the low-melting-point micron-tin based solder particles that are completely melted during sintering fill void gaps between the silver nanoparticles that are not completely melted, such that the problems of existing nano silver paste of low stacking density during non-pressure sintering, high porosity, severe volume contraction, susceptibility to cracking, and low interface soldering rate are solved, thereby improving the mechanical properties and reliability of interconnect positions.

Lastly, the method for preparing nano silver paste of the present application is based on scalable production, simple in process, low in cost, strong in operability, and significant in economic benefit, and may achieve mass production.

### DETAILED DESCRIPTION OF THE EMBODIMENTS

Specific implementations of the present application are further described in detail below with reference to the embodiments. The following embodiments are used to illustrate the present application, but not to limit the scope of the present application.

### Embodiment I

This embodiment provides nano silver paste. The nano silver paste included nano silver powder of which average particle size was 30 nm, Sn42Bi58 alloy particles (a melting point being 139° C.) of which average particle size was 5 μm, a diluent that forms the particles into paste, a dispersing agent that prevented powder in the silver paste from aggregating, and a reducing agent that was used for reducing an oxide layer of a soldered face and a metal particle oxide layer in the silver paste during sintering. A mass ratio of the nano silver powder to the micron Sn42Bi58 alloy particles was 200:1. The diluent was ethylene glycol and n-butane with a mass ratio being 1:2; and the mass percent of the diluent in an entire nano silver paste system was 2%. The dispersing agent was potassium dodecyl sulphate and sodium polybutenoate with a mass ratio being 3:1; and the mass percent of the dispersing agent in the entire nano silver paste system was 1.2%. The reducing agent was abietic acid and acetic acid with a mass ratio being 1:4; and the mass percent of the reducing agent in the entire nano silver paste system was 0.5%.

The method for preparing nano silver paste included the following steps.

The nano silver powder of which average particle size was 30 nm was obtained by a method of chemically reducing a silver salt solution, and drying a silver deposition layer in a negative pressure environment under 100 Pa.

A Sn42Bi58 alloy was prepared according to the ratio of alloy components (a mass ratio of Sn and Bi being (42:58)) of tin-based solder, and the Sn42Bi58 alloy was ground through a vacuum grinding machine, so as to obtain the Sn42Bi58 alloy particles of which average particle size was 5 μm.

The diluent was prepared with the ethylene glycol and the n-butane with the mass ratio being 1:2 in a proportion that the total mass percent in the entire nano silver paste system was 2%. The dispersing agent was prepared with the potassium dodecyl sulphate and the sodium polybutenoate with the mass ratio being 3:1 at a proportion that the total mass percent in the entire nano silver paste system was 1.2%. The reducing agent was prepared with the abietic acid and the acetic acid with the mass ratio being 1:4 at a proportion that the total mass percent in the entire nano silver paste system was 0.5%.

The nano silver powder and the micron Sn42Bi58 particles were added, according to a mass ratio of 200:1, a mixed solvent that was prepared included the reducing agent, the dispersing agent, and the diluent, and uniform mixing was performed by means of mechanical stirring, so as to obtain the nano silver paste mixed with the micron-tin based solder particles.

### Embodiment II

This embodiment provides nano silver paste. The nano silver paste included nano silver powder of which average particle size was 20 nm, mixed nano silver powder consisting of the nano silver powder of which average particle size was 100 nm and with a mass ratio being 5:3, and Sn96.5Ag3.5 alloy particles (a melting point being 221° C.) of which average particle size was 10 μm, the mass ratio of the mixed nano silver powder to the micron Sn96.5Ag3.5 alloy particles being 160:1, and further included a diluent that forms the particles into paste, a dispersing agent that prevents powder in the silver paste from aggregating, and a reducing agent that was used for reducing an oxide layer of a soldered face and a metal particle oxide layer in the silver paste during sintering. The diluent was hexanone and n-pentane with a mass ratio being 3:2; and the mass percent of the diluent in an entire nano silver paste system was 3.5%. The dispersing agent was polyethylene amide and potassium polyacrylate with a mass ratio being 4:3; and the mass percent of the dispersing agent in the entire nano silver paste system was 1.9%. The reducing agent was oxalic acid and adipic acid with a mass ratio being 2:1; and the mass percent of the reducing agent in the entire nano silver paste system was 0.8%.

The method for preparing nano silver paste included the following steps.

The nano silver powder of which average particle sizes were respectively 20 nm and 100 nm was obtained by a method of chemically reducing a silver salt solution, and drying a silver deposition layer in a negative pressure environment under 100 Pa.

A Sn96.5Ag3.5 alloy was prepared according to alloy components of the tin-based solder, and the Sn96.5Ag3.5 alloy was ground through the vacuum grinding machine, so as to obtain the Sn96.5Ag3.5 alloy particles of which average particle size was 10 μm.

The diluent was prepared with the hexanone and the n-pentane with the mass ratio being 3:2 in a proportion that the total mass percent in the entire nano silver paste system was 3.5%. The dispersing agent was prepared with the polyethylene amide and the potassium polyacrylate with the mass ratio being 4:3 at a proportion that the total mass percent in the entire nano silver paste system was 1.9%. The reducing agent was prepared with the oxalic acid and the adipic acid with the mass ratio being 2:1 at a proportion that the total mass percent in the entire nano silver paste system was 0.8%.

The nano silver powder (the mass ratio of the nano silver powder with the average particle size being 20 nm and the nano silver powder with the average particle size being 100 nm being 5:3) and the micron Sn96.5Ag3.5 particles were added, according to a mass ratio of 160:1, a mixed solvent that was prepared included the reducing agent, the dispersing agent, and the diluent, and uniform mixing is performed by means of magnetic stirring, so as to obtain the nano silver paste mixed with the micron-tin based solder particles.

### Embodiment III

This embodiment provides nano silver paste. The nano silver paste included mixed nano silver powder consisting of nano silver powder of which average particle size was 10 nm, nano silver powder of which average particle size was 120 nm, and nano silver powder of which average particle size was 800 nm, with a mass ratio being 7:4:1, included Sn99.3Cu0.7 alloy particles (a melting point being 227° C.) of which average particle size was 15 μm, the mass ratio of the mixed nano silver powder to the micron Sn99.3Cu0.7 alloy particles being 120:1, and further included a diluent that forms the particles into paste, a dispersing agent that prevented powder in the silver paste from aggregating, and a reducing agent that was used for reducing an oxide layer of a soldered face and a metal particle oxide layer in the silver paste during sintering. The diluent was n-pentane and ethyl acetate with a mass ratio being 2:5; and the mass percent of the diluent in an entire nano silver paste system was 5%. The dispersing agent was polyacrylamide and sodium dodecyl sulfate with a mass ratio being 1:3; and the mass percent of the dispersing agent in the entire nano silver paste system was 2.2%. The reducing agent was glutaric acid and abietic acid with a mass ratio being 3:1; and the mass percent of the reducing agent in the entire nano silver paste system was 1%.

The method for preparing nano silver paste included the following steps.

The nano silver powder of which average particle sizes were respectively 10 nm, 120 nm, and 800 nm was obtained by a method of chemically reducing a silver salt solution, and drying a silver deposition layer in a negative pressure environment under 100 Pa.

A Sn99.3Cu0.7 alloy was prepared according to alloy components of the tin-based solder, and the Sn99.3Cu0.7 alloy was ground through the vacuum grinding machine, so as to obtain the Sn99.3Cu0.7 alloy particles of which average particle size was 15 μm.

The diluent was prepared with the n-pentane and the ethyl acetate with the mass ratio being 2:5 in a proportion that the total mass percent in the entire nano silver paste system was 5%. The dispersing agent was prepared with the polyacrylamide and the sodium dodecyl sulfate with the mass ratio being 1:3 at a proportion that the total mass percent in the entire nano silver paste system was 2.2%. The reducing agent was prepared with the glutaric acid and the abietic acid with the mass ratio being 3:1 at a proportion that the total mass percent in the entire nano silver paste system was 1%.

The nano silver powder (the mass ratio of the nano silver powder with the average particle size being 10 nm, the nano silver powder with the average particle size being 120 nm and the nano silver powder with the average particle size being 800 nm being 7:4:1) and the micron Sn99.3Cu0.7 alloy particles were added, according to a mass ratio of 120:1, a mixed solvent that was prepared included the reducing agent, the dispersing agent, and the diluent, and uniform mixing was performed by means of mechanical stirring, so as to obtain the nano silver paste mixed with the micron-tin based solder particles.

### Embodiment IV

This embodiment provided nano silver paste. The nano silver paste included mixed nano silver powder consisting of nano silver powder of which average particle size was 25 nm, nano silver powder of which average particle size was 70 nm, and nano silver powder of which average particle size was 1200 nm, with a mass ratio being 9:5:1, included mixed low-melting-point micron alloy particles (a mass ratio being 4:1) consisting of Sn42Bi57Ag1 alloy particles (a melting point being 139° C.) of which average particle size was 20 μm and Sn96.5Ag3Cu0.5 alloy particles (a melting point being 217° C.), the mass ratio of the mixed nano silver powder to the mixed low-melting-point micron alloy particles being 30:1, and further included a diluent that forms the particles into paste, a dispersing agent that prevented powder in the silver paste from aggregating, and a reducing agent that was used for reducing an oxide layer of a soldered face and a metal particle oxide layer in the silver paste during sintering. The diluent was n-pentane, propylene glycol and ethyl acetate with a mass ratio being 1:3:4; and the mass percent of the diluent in an entire nano silver paste system was 8%. The dispersing agent was polyethylene amide, sodium polyacrylate and sodium dodecyl sulfate with a mass ratio being 1:2:4; and the mass percent of the dispersing agent in the entire nano silver paste system was 2.5%. The reducing agent was oxalic acid and abietic acid with a mass ratio being 1:4; and the mass percent of the reducing agent in the entire nano silver paste system was 1.2%.

The method for preparing nano silver paste included the following steps.

The nano silver powder of which average particle sizes were respectively 25 nm, 70 nm, and 1200 nm was obtained by a method of chemically reducing a silver salt solution, and drying a silver deposition layer in a negative pressure environment under 100 Pa.

A Sn96.5Ag3Cu0.5 alloy and a Sn42Bi57Ag1 alloy were respectively prepared according to alloy components of the tin-based solder, and the Sn96.5Ag3Cu0.5 alloy and the Sn42Bi57Ag1 alloy were respectively ground through the vacuum grinding machine, so as to obtain the Sn42Bi57Ag1 alloy particles and the Sn96.5Ag3Cu0.5 alloy particles with the average particle size being 20 μm.

The diluent was prepared with the n-pentane, the propylene glycol and the ethyl acetate with the mass ratio being 1:3:4 in a proportion that the total mass percent in the entire nano silver paste system was 8%. The dispersing agent was prepared with the polyethylene amide, the sodium polyacrylate and the sodium dodecyl sulfate with the mass ratio being 1:2:4 at a proportion that the total mass percent in the entire nano silver paste system was 2.5%. The reducing agent was prepared with the oxalic acid and the abietic acid with the mass ratio being 1:4 at a proportion that the total mass percent in the entire nano silver paste system was 1.2%.

The nano silver powder (the mass ratio of the nano silver powder with the average particle size being 25 nm, the nano silver powder with the average particle size being 70 nm and the nano silver powder with the average particle size being 1200 nm being 9:5:1) and the micron alloy particles (the mass ratio of the Sn42Bi57Ag1 alloy particles to the Sn96.5Ag3Cu0.5 alloy particles being 4:1) were added, according to a mass ratio of 30:1, a mixed solvent that was prepared includes the reducing agent, the dispersing agent, and the diluent, and uniform mixing was performed by means of magnetic stirring, so as to obtain the nano silver paste mixed with the micron-tin based solder particles.

### Embodiment V

This embodiment provided nano silver paste. The nano silver paste included mixed nano silver powder consisting of nano silver powder of which average particle size was 15 nm, nano silver powder of which average particle size was 60 nm, nano silver powder of which average particle size was 900 nm, and nano silver powder of which average particle size was 1500 nm, with a mass ratio being 12:9:5:1, included mixed low-melting-point micron alloy particles consisting of Sn64Bi35Ag1 alloy particles (a melting point range being about 139-180° C.) of which average particle size was 50 μm, Sn96Ag2.5Bi1Cu0.5 alloy particles (a melting point being about 215° C.) of which average particle size was 10 μm, and SnSb5 alloy particles (a melting point being about 240° C.) of which average particle size was 2 μm, with a mass ratio being 11:5:2, the mass ratio of the mixed nano silver powder to the mixed low-melting-point micron alloy particles being 80:1, and further included a diluent that forms the particles into paste, a dispersing agent that prevents powder in the silver paste from aggregating, and a reducing agent that was used for reducing an oxide layer of a soldered face and a metal particle oxide layer in the silver paste during sintering. The diluent was heptane, butanol and ethyl acetate with a mass ratio being 1:2:5; and the mass percent of the diluent in an entire nano silver paste system was 6%. The dispersing agent was potassium polyacrylate, polyacrylamide and sodium dodecyl sulfate with a mass ratio being 1:1:2; and the mass percent of the dispersing agent in the entire nano silver paste system was 3%. The reducing agent was acetic acid, glutaric acid and abietic acid with a mass ratio being 1:3:4; and the mass percent of the reducing agent in the entire nano silver paste system was 1.5%.

The method for preparing nano silver paste included the following steps.

The nano silver powder of which average particle sizes were respectively 15 nm, 60 nm, 900 nm, and 1500 nm was obtained by a method of chemically reducing a silver salt solution, and drying a silver deposition layer in a negative pressure environment under 100 Pa.

A Sn64Bi35Ag1 alloy, Sn96Ag2.5Bi1Cu0.5 alloy and a SnSb5 alloy were respectively prepared according to alloy components of the tin-based solder, and were respectively ground through the vacuum grinding machine, so as to obtain the Sn64Bi35Ag1 alloy particles of which average particle size was 50 μm, the Sn96Ag2.5Bi1Cu0.5 alloy particles of which average particle size was 10 μm, and the SnSb5 alloy particles of which average particle size was 2 μm.

The diluent was prepared with the heptane, the butanol and the ethyl acetate with the mass ratio being 1:2:5 in a proportion that the total mass percent in the entire nano silver paste system was 6%. The dispersing agent was prepared with the potassium polyacrylate, the polyacrylamide and the sodium dodecyl sulfate with the mass ratio being 1:1:2 at a proportion that the total mass percent in the entire nano silver paste system was 3%. The reducing agent was prepared with the acetic acid, the glutaric acid and the abietic acid with the mass ratio being 1:3:4 at a proportion that the total mass percent in the entire nano silver paste system was 1.5%.

The nano silver powder (the mass ratio of the nano silver powder with the average particle size being 15 nm, the nano silver powder with the average particle size being 60 nm, the nano silver powder with the average particle size being 900 nm, and the nano silver powder with the average particle size being 1500 nm being 12:9:5:1) and the micron alloy particles (a mass ratio of the Sn64Bi35Ag1 alloy particles, the Sn96Ag2.5Bi1Cu0.5 alloy particles, and the SnSb5 alloy particles being 11:5:2) were added, according to a mass ratio of 80:1, a mixed solvent that was prepared included the reducing agent, the dispersing agent, and the diluent, and uniform mixing was performed by means of mechanical stirring, so as to obtain the nano silver paste mixed with the micron-tin based solder particles.

In order to further verify the technical effects of the present application, a sintering test was performed below on the nano silver paste of the present application. A detection sample and a sintered material that were used in the sintering test were specifically as follows.

Detection Sample

Embodiment V of the present application: the nano silver paste mixed with the micron-tin based solder particles

Comparative example I: the nano silver paste that was not added with the micron-tin based solder particles (other conditions being the same as that in Embodiment V of the present application)

Sintered material: an oxygen-free copper plate with the thickness being 1.5 mm and a sintering area being 10 mm*8 mm.

Sintering mode: the nano silver paste of Comparative example I or the nano silver paste of Embodiment V of the present application with the thickness being 0.1 mm was clamped between two oxygen-free copper plates, and atmospheric-pressure sintering without additional pressure application was performed simultaneously on the nano silver paste of Comparative example I and the nano silver paste of Embodiment V of the present application.

A performance test was performed below on a sintered layer. The performance test of the sintered layer included the porosity, shear strength and thermal conductivity of the sintered layer, and the porosity of the sintered layer which has been subjected to temperature cycling shock. The porosity of the sintered layer was tested by an ultrasound scanner or an X-Ray detector; the shear strength was tested by an electronic universal testing machine; and the thermal conductivity was tested by a laser flash-color thermal conductivity analyzer.

If the porosity of the sintered layer was smaller, it indicated that the quality of the sintered layer that was sintered by the nano silver paste was better; and if changes in the porosity of the sintered layer which has been subjected to temperature cycling shock were smaller, it indicated that the degree of degradation of the sintered layer was lower, that is, the resistance of the sintered layer to temperature shock was stronger. If the shear strength of the sintered layer was larger, it indicated that the resistance of the sintered layer to mechanical shock was stronger. If the thermal conductivity of the sintered layer was larger, it indicated that the capability of the sintered layer to conduct heat generated during operation of a power device was stronger.

Experiment I: Sintered Layer Porosity and Thermal Conductivity Test

TABLE 1
Porosity and thermal conductivity of sintered layer

| Number | | Thermal | | | Thermal |
|---|---|---|---|---|---|
| (Comparative | | conductivity/ | Number | | conductivity/ |
| example I) | Porosity/% | (W/m · K) | (Embodiment V) | Porosity/% | (W/m · K) |
| 1# | 19.42 | 187 | 11# | 9.63 | 237 |
| 2# | 20.58 | 174 | 12# | 9.51 | 241 |
| 3# | 18.96 | 192 | 13# | 8.94 | 258 |
| 4# | 19.92 | 181 | 14# | 9.40 | 245 |
| 5# | 20.85 | 168 | 15# | 9.74 | 232 |
| 6# | 19.73 | 183 | 16# | 9.25 | 249 |
| 7# | 18.81 | 194 | 17# | 8.71 | 261 |
| 8# | 20.32 | 176 | 18# | 9.18 | 252 |
| 9# | 19.55 | 185 | 19# | 8.67 | 263 |
| 10# | 19.21 | 189 | 20# | 9.34 | 246 |
| Mean value | 19.74 | 183 | Mean value | 9.24 | 248 |

From Table 1, it may be seen that, after sintering, compared with the nano silver paste of Comparative example I, the porosity of the sintered layer in the nano silver paste of Embodiment V of the present application was reduced by about 53.2% ((19.74−9.24)/19.74×100%=53.2%) on average, and the thermal conductivity was increased by about 35.5% ((248−183)/183×100%=35.5%).

Experiment II: Sintered Layer Shear Strength Test

After sintering with the nano silver paste of Comparative example I and the nano silver paste of Embodiment V of the present application in Experiment I, five groups of corresponding sintered layers were respectively subjected to a shear strength test, and test results were shown in Table 2.

TABLE 2
Shear strength of sintered layer

| Number | | | |
|---|---|---|---|
| (Comparative | Shear | Number | Shear |
| example I) | strength//MPa | (Embodiment V) | strength//MPa |
| 1# | 27.4 | 6# | 34.7 |
| 2# | 26.7 | 7# | 34.9 |
| 3# | 28.1 | 8# | 35.6 |
| 4# | 27.2 | 9# | 35.2 |
| 5# | 26.3 | 10# | 34.4 |
| Mean value | 27.1 | Mean value | 35.0 |

From Table 2, it may be seen that, after sintering, compared with the nano silver paste of Comparative example I, the shear strength of the sintered layer in the nano silver paste of Embodiment V of the present application was increased by about 29.2% ((35.0-27.1)/27.1×100%=29.2%).

Experiment III: Porosity (Degree of Degradation) of Sintered Layer which has been Subjected to Temperature Cycling Shock

After sintering with the nano silver paste of Comparative example I and the nano silver paste of Embodiment V of the present application in Experiment I, five groups of corresponding sintered layers were respectively subjected to temperature cycling shock at −40° C.-125° C. for 1000 times, and then the porosity of the sintered layer was detected (when the porosity of the sintered layer after temperature cycling shock had a larger change than that of the sintered layer before temperature cycling shock, it indicated that the degree of degradation was relatively severe, where degree of degradation=porosity after temperature cycling shock−porosity before temperature cycling shock), and test results were shown in Table 3.

TABLE 3
Degree of degradation of sintered layer which
has been subjected to temperature cycling shock

| | Porosity | Porosity | | | Porosity | Porosity | |
|---|---|---|---|---|---|---|---|
| Number | before | after | | | before | after | |
| (Compar- | temper- | temper- | Degree of | | temper- | temper- | Degree of |
| ative | ature | ature | degra- | Number | ature | ature | degra- |
| example | cycling | cycling | dation/ | (Embodi- | cycling | cycling | dation/ |
| I) | shock/% | shock/% | % | ment V) | shock/% | shock/% | % |
| 1# | 19.73 | 23.11 | 3.38 | 6# | 9.25 | 11.23 | 1.98 |
| 2# | 18.81 | 21.36 | 2.55 | 7# | 8.71 | 10.56 | 1.85 |
| 3# | 20.32 | 24.68 | 4.36 | 8# | 9.18 | 10.78 | 1.60 |
| 4# | 19.55 | 22.53 | 2.98 | 9# | 8.67 | 10.34 | 1.67 |
| 5# | 19.21 | 23.17 | 3.96 | 10# | 9.34 | 11.45 | 2.11 |
| Mean | 19.52 | 22.97 | 3.45 | Mean | 9.03 | 10.87 | 1.84 |
| value | | | | value | | | |

From Table 3, it may be seen that, after the sintered layers which were sintered with the nano silver paste of Comparative example I and the nano silver paste of Embodiment V of the present application were subjected to temperature cycling shock at −40° C.-125° C. for 1000 times, the degree of degradation of the sintered layer in the nano silver paste of Embodiment V of the present application was obviously lower than that of the sintered layer in the nano silver paste of Comparative example I, and compared with the nano silver paste of Comparative example I, the degree of degradation of the sintered layer in the nano silver paste of Embodiment V of the present application was reduced by 46.7%((3.45−1.84)/3.45×100%=46.7%).

In order to further verify the technical effects of the present application, a sintering test was performed below by using, as Comparative examples, the nano silver paste in Embodiment I of the present application that was added with the micron-tin based solder particles with different particle sizes and different amounts added. A detection sample and a sintered material that were used in the sintering test were specifically as follows.

Detection sample: the nano silver paste in Embodiment I of the present application that was added with the micron-tin based solder particles with different particle sizes and different amounts added

Embodiment I of the present application: the nano silver paste that was prepared according to a mass ratio of the nano silver powder to micron Sn42Bi58 particles with an average particle size being 5 μm being 200:1

Comparative example II: the nano silver paste that was prepared according to the mass ratio of the nano silver powder to the micron Sn42Bi58 particles with the average particle size being 5 μm being 10:1 (other conditions being the same as that in Embodiment I of the present application)

Comparative example III: the nano silver paste that was prepared according to the mass ratio of the nano silver powder to the micron Sn42Bi58 particles with the average particle size being 5 μm being 800:1 (other conditions being the same as that in Embodiment I of the present application)

Comparative example IV: the nano silver paste that was prepared according to the mass ratio of the nano silver powder to the micron Sn42Bi58 particles with the average particle size being 250 μm being 200:1 (other conditions being the same as that in Embodiment I of the present application)

Sintered material: an oxygen-free copper plate with the thickness being 1.5 mm and a sintered area being 10 mm*8 mm

Sintering mode: the nano silver paste of Embodiment I of the present application, Comparative example II, Comparative example III, and Comparative example IV with the thickness being 0.1 mm was respectively clamped between two oxygen-free copper plates, and atmospheric-pressure sintering without additional pressure application was performed simultaneously on the nano silver paste of Embodiment I of the present application, Comparative example II, Comparative example III, and Comparative example IV.

The degree of degradation of the sintered layer which has been subjected to temperature cycling shock at −40° C.-125° C. for 1000 times was tested, and test results were shown in Table 4.

TABLE 4
Degree of degradation of sintered layer which
has been subjected to temperature cycling shock

| Number | | Number | | Number | | | |
|---|---|---|---|---|---|---|---|
| (Compar- | Degree | (Compar- | Degree | (Compar- | Degree | | Degree |
| ative | of | ative | of | ative | of | Number | of |
| example | degra- | example | degra- | example | degra- | (Embodi- | degra- |
| II) | dation/% | III) | dation/% | IV) | dation/% | ment I) | dation/% |
| 1# | 6.07 | 6# | 3.08 | 11# | 4.35 | 16# | 2.16 |
| 2# | 5.92 | 7# | 3.55 | 12# | 4.46 | 17# | 2.39 |
| 3# | 5.73 | 8# | 3.64 | 13# | 4.57 | 18# | 2.53 |
| 4# | 5.65 | 9# | 3.17 | 14# | 4.32 | 19# | 2.28 |
| 5# | 5.46 | 10# | 3.62 | 15# | 4.29 | 20# | 2.37 |
| Mean | 5.77 | Mean | 3.41 | Mean | 4.40 | Mean | 2.35 |
| value | | value | | value | | value | |

From Table 4, it may be seen that, after the sintered layers which were sintered with the nano silver paste of Embodiment I of the present application, Comparative example II, Comparative example III, and Comparative example IV were subjected to temperature cycling shock at −40° C.-125° C. for 1000 times, the degree of degradation of the sintered layer in the nano silver paste of Embodiment I of the present application was obviously lower than that of the sintered layer in the nano silver paste of Comparative example II, Comparative example III, and Comparative example IV; and the degree of degradation of the sintered layer in the nano silver paste of Embodiment I of the present application was reduced by about 59.3%((5.77−2.35)/5.77×100%=59.3%) compared with the degree of degradation of the sintered layer in the nano silver paste of Comparative example II, was reduced by about 31.1%((3.41−2.35)/3.41×100%=31.1%) compared with the degree of degradation of the sintered layer in the nano silver paste of Comparative example III, and was reduced by about 46.6%((4.40−2.35)/4.40×100%=46.6%) compared with the degree of degradation of the sintered layer in the nano silver paste of Comparative example IV.

What is claimed is:

1. A nano silver paste, comprising nano silver powder, micron-tin based solder particles, a reducing agent, a dispersing agent, and a diluent;
wherein a mass ratio of the nano silver powder to the micron-tin based solder particles is 20-500:1.

2. The nano silver paste according to claim 1, wherein a material of the micron-tin based solder particles is a tin-base alloy of which melting point is within a range of 120-250° C.

3. The nano silver paste according to claim 2, wherein the material of the micron-tin based solder particles is at least one of a SnBi series alloy, a SnBiAg series alloy, a SnAg series alloy, a SnCu series alloy, a SnAgCu series alloy, a SnSb series alloy, a SnSbCu series alloy, a SnSbAg series alloy, a SnAgCuBi series alloy, or a SnAgCuSb series alloy.

4. The nano silver paste according to claim 1, wherein
an average particle size of the nano silver powder is 5-3000 nm; and
an average particle size of the micron-tin based solder particles is 0.1-100 μm.

5. The nano silver paste according to claim 4, wherein
an average particle size of the nano silver powder is 10-1500 nm; and
an average particle size of the micron-tin based solder particles is 0.5-50 μm.

6. The nano silver paste according to claim 1, wherein the nano silver powder is the nano silver powder with one average particle size or a mixture of the nano silver powder with more than two different average particle sizes.

7. The nano silver paste according to claim 1, wherein the mass ratio of the nano silver powder to the micron-tin based solder particles is 30-200:1.

8. The nano silver paste according to claim 1, wherein
the diluent is at least one of alcohol, hydrocarbon, ketone, or ester;
a mass percent of the diluent in a system is 2%-8%;
the dispersing agent is at least one of polymerized hydrocarbon amide, polymerized hydrocarbon acid salt, or alkyl acid salt;
a mass percent of the dispersing agent in the system is 0.1%-3%;
the reducing agent is at least one of organic acids; and
a mass percent of the reducing agent in the system is 0.1%-1.5%.
